(19) United States
(12) Patent Application Publication
(10) Pub. No.: US 2021/0184545 A1
(43) Pub. Date: Jun. 17, 2021

(54) System and Method for Ethernet Communication with a Rotary Coupler

(71) Applicant: Rockwell Automation Technologies, Inc., Mayfield Heights, OH (US)

(72) Inventors: Xikai Sun, Shanghai (CN); Robert H. Schmidt, Mequon, WI (US); Dayin Xu, Shanghai (CN)

(21) Appl. No.: 16/713,119

(22) Filed: Dec. 13, 2019

(51) Int. Cl. H02K 11/35; H02K 3/42; H02K 11/33; H02K 21/16; H04B 1/40

(52) U.S. Cl. CPC H02K 11/35; H02K 3/42; H04B 1/40; H02K 21/16; H02K 11/33

(57) ABSTRACT

A contactless Ethernet communication technique adapted for communication between a rotor and a stator in a rotating machine is disclosed. Power is supplied to the rotor via a contactless power transfer system. The power energizes a transmitter on the rotating machine to generate data packets in an industrial protocol, such as EtherNet/IP, for transmission on an Ethernet physical link layer. A rotary coupler, such as a digital rotary transformer, is provided between the rotor and stator, where a rotating member on the rotor is communicatively coupled to a stationary member on the stator. The data packet is transmitted in the industrial protocol via the rotary coupler. A receiver on the stationary side may receive the data packet where some initial processing may be performed and the data retransmitted. Alternately, a network device may receive the data packet and pass it along the industrial network to a remote device for further processing.

### BACKGROUND INFORMATION

The subject matter disclosed herein relates generally to providing communication between a rotating object and a stationary object and, more specifically, to a system which utilizes a rotary coupler to provide communication between a rotating member and a stationary member in a rotary machine.

A traditional rotary machine includes a stationary member, such as a stator, and a rotating member, such as a rotor. When a machine is being controlled in a motoring operating mode, a controlled voltage is applied to a coil on the stator, where the controlled voltage has a variable magnitude and a variable frequency. The controlled voltage interacts with a magnetic field (e.g., permanent magnet machine) or electromagnetic field (e.g., induction or synchronous machine) emitted from the rotor or with a magnetic saliency (e.g., synchronous reluctance) machine to achieve desired operation of the motor. The rotor may be controlled from zero speed up to hundreds or thousands of revolutions per minute according to the requirements of an application.

Historically, there have been no electronic devices mounted on the rotor due, in part, to the challenges of providing power to the rotating member as well as transmitting data back from the rotating member to the stationary member. In recent advances, the present inventors have developed methods for providing power to the rotating member without contact between the rotating member and a stationary member. The recent developments allow for electronic devices to be mounted to and operate on the rotating member, such as the rotor in a motor. However, to fully realize the potential of the contactless power transfer, it is necessary also to provide communication between the rotating member and the stationary member.

Traditional wireless communication techniques, such as Bluetooth, ZigBee, or Ultra-wideband (UWB), that are normally well suited for low energy, short range communication face challenges when attempting to implement them within a motor. The data protocols themselves can suffer from a low data transfer rate or from reliability issues. Additionally, the controlled voltage applied to the stator coil is commonly generated using a modulation technique, such as pulse width modulation, which has the potential to generate radiated emissions within the motor that interfere with the wireless data transfer within the motor. Further, a network in communication with the rotating machine typically uses an industrial protocol, such as EtherNet/IP, which would require conversion from the first, wireless protocol into a second communication protocol when the wireless transfer is successful. Thus, these wireless communication techniques are not well-suited for use between a rotor and a stator in a motor.

Thus, it would be desirable to provide a contactless Ethernet communication technique adapted for communication between a rotor and a stator in a rotating machine.

### BRIEF DESCRIPTION

According to one embodiment of the invention, a system for providing contactless communication between a rotating member and a stationary member in a rotary machine includes an electronic circuit mounted on the rotating member of the rotary machine, a power supply operative to provide power to the electronic circuit, and a transmitter operatively mounted in the electronic circuit. The transmitter receives power from the power supply and is configured to generate Ethernet data packets. The system also includes a primary winding mounted to the rotating member of the rotary machine and a secondary winding mounted to the stationary member of the rotary machine. The primary winding is electrically connected to the transmitter to receive the Ethernet data packets, and the secondary winding is spaced apart from the primary winding by an air gap. The secondary winding receives the Ethernet data packets via coupling between the primary and secondary windings. A receiver is operatively connected to the secondary winding to receive the Ethernet data packets generated by the transmitter mounted on the rotating member of the rotary machine.

According to another embodiment of the invention, a method for providing communication between a rotating member and a stationary member in a rotary machine is disclosed. Ethernet data packets are generated with a transmitter operatively mounted on the rotating member of the rotary machine, and the Ethernet data packets are sent from the transmitter to a primary winding mounted on the rotating member of the rotary machine. The Ethernet data packets are received at a secondary winding mounted to a stationary member of the rotary machine. The secondary winding is spaced apart from the primary winding by an air gap, and the secondary winding receives the Ethernet data packets via coupling between the primary and secondary windings. The Ethernet data packets are transmitted from the secondary winding to a receiver operatively connected to the secondary winding.

According to yet another embodiment of the invention, a system for providing communication between a rotating member and a stationary member in a rotary machine includes a power supply external to the rotary machine, a power transmission device mounted on the stationary member of the rotary machine and operatively connected to the power supply to receive power from the power supply, and a power receiving device mounted on the rotating member of the rotary machine. The power receiving device is operative to receive power from the power transmission device via contactless delivery of power. An electronic circuit mounted on the rotating member of the rotary machine receives power from the power receiving device. A transmitter configured to generate Ethernet data packets is operatively mounted in the electronic circuit. The system also includes a digital rotary transformer which has a primary side mounted to the rotating member of the rotary machine and a secondary side mounted to the stationary member of the rotary machine. The primary side of the digital rotary transformer is operatively connected to the transmitter to receive the Ethernet data packets, and the Ethernet data packets are transmitted between the primary side and the secondary side. A receiver is operatively connected to the secondary winding to receive the Ethernet data packets generated by the transmitter mounted on the rotating member of the rotary machine.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a perspective view of an exemplary industrial control application incorporating the present invention;

FIG. 2 is a partial block diagram representation of the exemplary industrial control application of FIG. 1

FIG. 3 is a partial sectional view of a motor according to one embodiment of the invention;

FIG. 4 is a schematic representation of a communication circuit between a rotating member of a motor and a motor drive according to one embodiment of the invention;

FIG. 5 is a partial sectional view of a motor incorporating one embodiment of a rotary coupler;

FIG. 6 is a partial sectional view of a motor incorporating another embodiment of a rotary coupler; and

FIG. 7 is a partial sectional view of a motor incorporating still another embodiment of a rotary coupler.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes a contactless Ethernet communication technique adapted for communication between a rotor and a stator in a rotating machine. Power is supplied to the rotor via a contactless power transfer system. A transmitter on the rotating machine generates data packets in an industrial protocol, such as EtherNet/IP, for transmission on an Ethernet physical link layer. A rotary coupler is provided between the rotor and stator, where a rotating member on the rotor is communicatively coupled to a stationary member on the stator. The rotary coupler may include, for example, a digital rotary transformer. The data packet is transmitted in the industrial protocol via the rotary coupler. A receiver on the stationary side may receive the data packet where some initial processing may be performed and the data retransmitted. Alternately, a network device, such as a gateway, router, or switch may receive the data packet and pass it along the industrial network to a remote device for further processing.

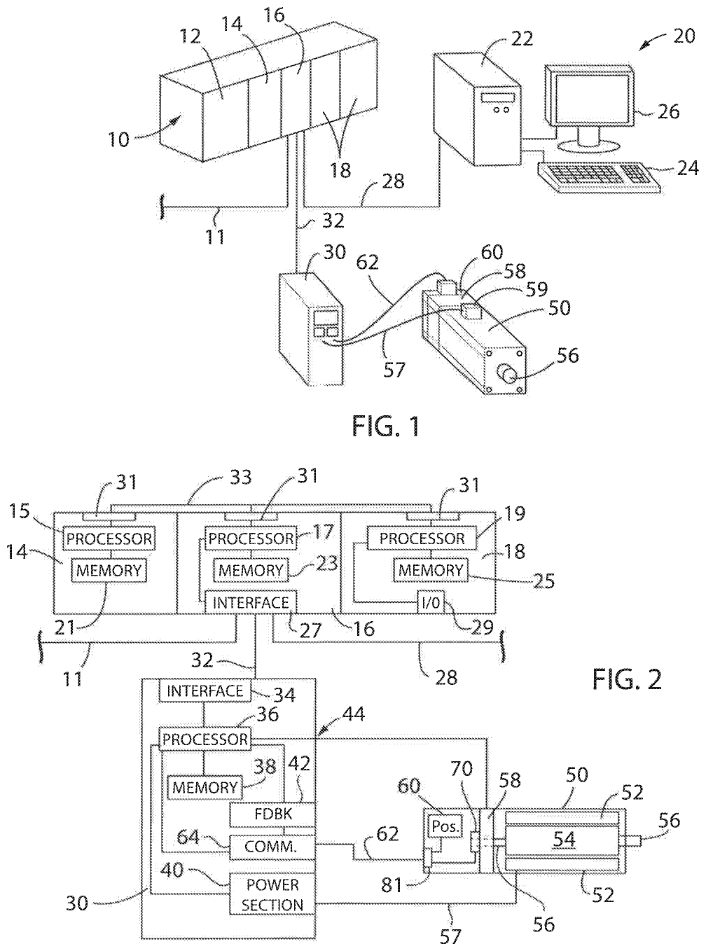

Turning initially to FIG. 1, an exemplary industrial control system includes an industrial controller 10 in communication with a motor drive 30 and a remote processing device 20. As illustrated, the industrial controller 10 is modular and may be made up of numerous different modules connected together in a rack or mounted to a rail. Additional modules may be added or existing modules removed and the industrial controller 10 reconfigured to accommodate the new configuration. Optionally, the industrial controller 10 may have a predetermined and fixed configuration. In the illustrated embodiment, the industrial controller 10 includes a power supply module 12, a processor module 14, a network module 16, and two additional modules 18 that may be selected according to the application requirements and may be, for example, analog or digital input or output modules.

One or more remote processing devices 20 may be connected to the industrial control network. The remote processing device may be an operator interface located proximate to the industrial controller, a desktop computer located at a separate facility from the industrial controller, or a combination thereof. The remote processing device 20 may include a processing unit 22, input device 24, including, but not limited to, a keyboard, touchpad, mouse, trackball, or touch screen, and a display device 26. It is contemplated that each component of the remote processing device may be incorporated into a single unit, such as an industrial computer, laptop, or tablet computer. It is further contemplated that multiple display devices 26 and/or multiple input devices 24 may be distributed about the controlled machine or process and connected to one or more processing units 22. The remote processing device 20 may be used to display operating parameters and/or conditions of the controlled machine or process, receive commands from the operator, or change and/or load a control program or configuration parameters. An interface cable 28 connects the remote processing device 20 to the industrial controller 10.

The industrial controller 10 is connected to other devices by one or more networks according to the application requirements. As illustrated, interface cables 28, 32 connect the industrial controller 10 to the remote processing device 20 and the motor drive 30, respectively. It is contemplated that the interfaces cables 28, 32 may be a custom cable configured to communicate via a proprietary interface or may be any standard industrial network cable, including, but not limited to, EtherNet/IP, DeviceNet, or ControlNet. The network module 16 is configured to communicate according to the protocol of the network to which it is connected and may be further configured to translate messages between two different network protocols. An additional network cable 11 may be a standard Ethernet cable connected to a network external from the industrial network, such as the Internet or an intranet.

The industrial control network further includes a motor drive 30 and a motor 50. The motor drive 30 is connected to the industrial controller 10 via a network cable 32. As illustrated, the motor drive 30 is connected to a network module 16 to receive communications from the industrial controller 10. The communications may include configuration packets or operating commands generated by the processing module 14. Optionally, the industrial controller 10 may include another module (not shown) dedicated to communicating with the motor drive 30. The additional module may be, for example, a servo module, which is configured to generate motion profiles, velocity profiles, or other command profiles and transmit the commands to the motor drive 30.

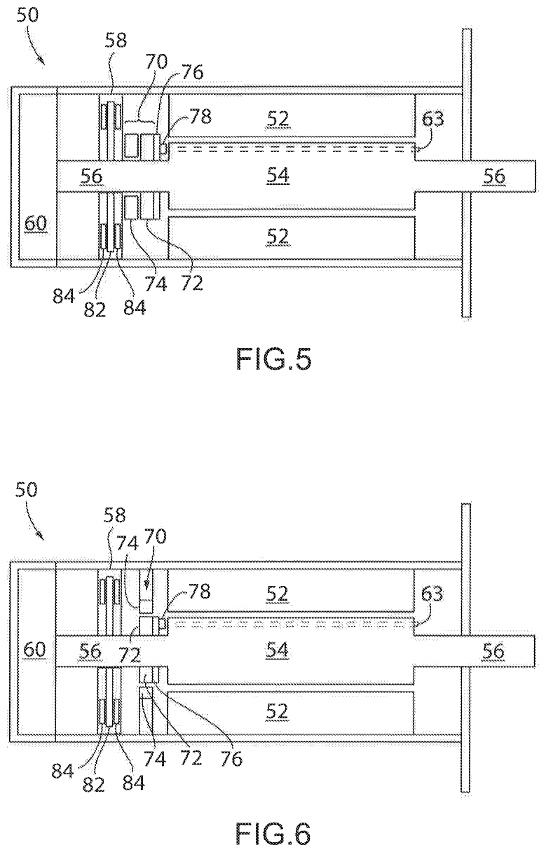

The motor drive 30 receives the commands, which indicate a desired operation of the motor 50, and generate a variable frequency and variable amplitude voltage for the motor to achieve the desired operation. A power cable 57 extends between the motor drive 30 and a junction box 59 on the motor to supply the variable frequency and variable amplitude voltage to the motor. A communication cable 62 extends between a first communication interface 64 (see also FIG. 2) in the motor drive 30 and a second communication interface in the motor 50. An encoder 60 is mounted to the rear of the motor 50 and generates a position feedback signal corresponding to an angular position of the motor 50. The position feedback signal may be provided directly to the motor drive via a dedicated position feedback cable (not shown) or, optionally, the position feedback signal may be transmitted via the communication cable 62 to the motor drive 30. The position feedback signal may be transmitted directly or after some initial processing, such as inserting the position information into a data packet for serial communications or converting the position signal to a velocity signal, is performed within the encoder 60 prior to sending the feedback signal to the motor drive 30. Optionally, the communication interface within the motor 50 may be integrated within the encoder 60. The position feedback information and additional data provided from a circuit within the motor 50 to the encoder 60 may be combined into a data packet by the encoder 60 for transmission to the motor drive 30. The illustrated embodiment further includes a brake module 58 mounted between the motor 50 and the encoder 60. A control signal is provided from an output 44 (see FIG. 2) of the motor drive 30 to release the brake and a feedback signal may be provided from the brake 58 to the motor drive 30 to indicate the brake is opened. With reference also to FIGS. 5 and 6, it is contemplated that the brake 58 may be a disc brake system in which a rotating disc 82 is mounted to the drive shaft 56. Calipers squeeze pads 84 together on each side of the rotating disc 82 to hold the disc in position, and the control signal is used to open the caliper, releasing the brake when motion is desired.

It is further contemplated that other sensors and/or actuators may be mounted to or within an extension of the housing for the motor 50 according to application requirements. For example, sensors such as a vibration sensor or a temperature sensor may be mounted at various locations within, on, or proximate to the housing of the motor 50 to monitor operating performance. Each of the sensors generates a signal that may be transmitted directly to the motor drive 30 or to an additional control module embedded within the housing of the motor 50. The additional control module may include, for example, logic circuits such as analog to digital converters, buffers, processors and the like to receive the signals from each sensor and to convert the signals to another format and/or to provide data for the communication interface for insertion into data packets which are transmitted to the motor drive 30. Additional conductors and/or cables may be connected between the motor drive 30 and the motor 50 according to the application requirements to transfer each of the control, communication, and/or feedback signals between the motor drive 30 and the motor 50.

Referring next to FIG. 2, a portion of the exemplary industrial control system shown in FIG. 1 is illustrated in block diagram form. Each of the modules 14, 16, 18 in the industrial controller 10 may include a processing device and memory. The functionality and size of the processing device and memory may vary according to the requirements of each module. As illustrated, each module 14, 16, 18 includes a processor 15, 17, 19 configured to execute instructions and to access or store operating data and/or configuration parameters stored in the corresponding memory device 21, 23, 25. The processors 15, 17, 19 may be any suitable processor according to the module requirements. It is contemplated that processors 15, 17, 19 may include a single processing device or multiple processing devices executing in parallel and may be implemented in separate electronic devices or incorporated on a single electronic device, such as a microprocessor, a field programmable gate array (FPGA) or application specific integrated circuit (ASIC). Similarly, the memory devices 21, 23, 25 may be a single device, multiple devices or may be incorporated in part or in whole within the FPGA or ASIC.

The modules may further include additional logic and/or control circuits according to the module requirements. Each I/O module 18, for example, includes input and/or output terminals and the associated circuitry 29 to connect the I/O module to an external device. The network module 16 includes a network interface 27 configured to receive data packets from the network media connected to the interface. According to the illustrated embodiment, the network interface 27 is connected to an external network via Ethernet cable 1I as well as the motor drive 30 and remote processing device 20 via the respective network cables 32, 28. The network module 16 may be configured to function as a gateway between networks and to convert data packets between protocols.

The motor drive 30 also includes a processing device and memory. As illustrated, the motor drive 30 includes a processor 36 configured to execute instructions and to access or store operating data and/or configuration parameters stored in the corresponding memory device 38. The processor 36 may be any suitable processor according to the module requirements. It is contemplated that processor 36 may include a single processing device or multiple processing devices executing in parallel and may be implemented in separate electronic devices or incorporated on a single electronic device, such as a microprocessor, a field programmable gate array (FPGA) or application specific integrated circuit (ASIC). Similarly, the memory devices 38 may be a single device, multiple devices or may be incorporated in part or in whole within the FPGA or ASIC. The motor drive 30 also includes a network interface 34 to communicate with the industrial controller 10 and/or other devices via the industrial network. A feedback circuit 42 is in communication with the communication interface 64 and receives position feedback information from the encoder 60 which is transmitted via the communication cable 62. The motor drive also includes a power section 40, where the power section 40 is configured to receive either AC or DC power from an external source and convert the external power to the variable frequency and variable amplitude voltage supplied to the motor. The variable frequency and variable amplitude voltage is provided to a stator 52 of the motor 50 which causes the rotor 54 and, in turn, the drive shaft 56 of the motor to rotate.

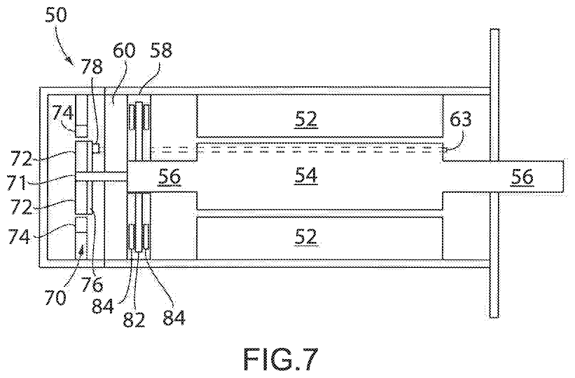

The drive shaft 56 may be a single shaft extending through the rotor 54 and protruding from one end or both ends based on the configuration of the motor 50. Optionally, the drive shaft 56 may include a first shaft portion extending from the front of the motor 50 and a second shaft portion extending toward the rear of the motor 50. According to still another embodiment, illustrated in FIG. 7, the drive shaft 56 may include a first shaft portion extending from the front of the motor 56, a second shaft portion 56 extending internally toward the rear of the motor, and a third shaft portion 71 coupled to the second shaft portion 56. The second shaft portion is sized appropriately to be coupled to the disc 82 within the brake 58 and the third shaft portion is sized to extend through the encoder 60 and to receive the digital rotary transformer 70 on the reverse side of the encoder 60. In any of the configurations described above, the drive shaft 56 or portions of the drive shaft rotate responsive to the variable frequency and variable amplitude voltage provided to the stator 52. The portion of the drive shaft 56 extending from the front of the motor 50 may be coupled to and control operation of a machine, gearbox, or the like that is mechanically coupled to the drive shaft 56. The portion of the drive shaft 56 extending toward the rear of the motor 50 may be coupled to the motor brake 58 and to a digital rotary transformer 70 as will be discussed in more detail below. The illustrated embodiment is intended to be exemplary and will be used herein for discussion purposes. It is understood that the drive shaft 56 may extend from just one side of the rotor 54 and be of sufficient length such that the motor brake and/or the digital rotary transformer 70 may be coupled to the same portion of the drive shaft 56 extending from the motor and coupled to a machine, gearbox, or the like. Further, the diameter of the drive shaft 56 may be uniform throughout its length or be varied according to the requirements of the device coupled to the drive shaft 56. As also illustrated in FIG. 7, the drive shaft may include multiple portions coupled together either directly or indirectly, for example, via gears. For purposes of discussion herein, it is contemplated that the drive shaft 56 includes one or more members that cause rotation of a primary winding 72 for the digital rotary transformer 70 in tandem with rotation of the rotating member of the motor 50.

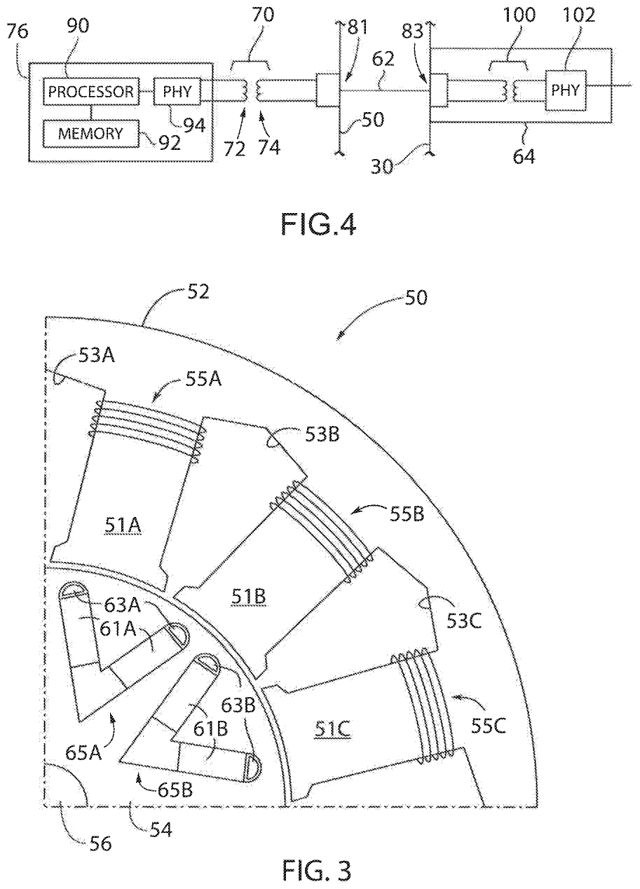

In addition to causing rotation of the rotor and drive shaft within the motor 50, the variable frequency and variable amplitude voltage may be utilized to transfer power from the stator 52 to a circuit mounted on the rotor 54. Turning next to FIG. 3, a sectional view of a permanent magnet (PM) motor is shown as one embodiment of a synchronous motor controlled by the motor drive 30. The PM motor 50 includes a rotor 54 having a number of poles 65A, 65B and a stator 52 having a number of windings 55A-55C. For ease of illustration, one quarter of the motor is shown. The full PM motor 50 includes twelve windings 55 and eight poles 65. As is understood in the art, each winding 55A-55C is wound around a tooth 51A-51C with the windings filling slots 53A-53C between adjacent teeth 51A-51C. Each winding 55A-55C consists of a number of turns, N, wrapped around the tooth 51A-51C. The PM motor 50 shown in FIG. 3 is an interior permanent magnet motor, and each pole 65A, 65B includes a v-shaped slot in which a pair of magnets 61A, 61B is inserted, where one magnet of the pair is inserted into each leg of the v-shaped slot. Optionally, each pole 65A, 65B may include a bar magnet and a single slot. It is contemplated that the slots may take various other shapes and be configured to receive magnets 61 having a complementary shape to be inserted within the slot without deviating from the scope of the invention.

Each slot also includes a portion of a pick-up coil 63 located within the slot. According to the illustrated embodiment, each pick-up coil 63A, 63B is wound at the end of each v-shaped slot between the magnet 61A, 61B and the outer periphery of the rotor 54. Each pick-up coil 63A, 63B may have a number of turns, where the coil is would in one direction through one end of the v-shaped slot, wound in the other direction through the other end of the v-shaped slot, and includes end-turns at each end of the rotor 54. Optionally, the rotor 54 may include a first slot in which the magnet 61 is inserted and a second slot configured to receive the pick-up coil 63. According to another embodiment, the rotor 54 may include a number of grooves or channels extending longitudinally along the length of the rotor 54 in which each of the pick-up coils 63 is received.

In operation, the motor drive 30 receives a reference signal, such as a speed reference, position reference, or a torque reference corresponding to desired operation of the motor 50 and regulates the amplitude and frequency of current and/or voltage supplied to the motor 50 to achieve the desired operation of the motor 50. In one embodiment of the invention, the power section 40 of the motor drive 30 includes a current regulator module (not shown) to control the current provided to the motor 50. The power section 40 uses the current values measured at the output of the motor drive 30 by current sensors. As is understood in the art, Park's transformation may be used to convert measured three-phase currents into a two-phase representation of the current along a quadrature axis (q-axis) and along a direct axis (d-axis). The q-axis current corresponds to the amount of torque produced by the motor 50 and the d-axis current corresponds to the flux established between the rotor 54 and the stator 52 in the motor 50. The magnitude of flux is a function of the field strength of the permanent magnets 61 in the rotor 54, of the windings 55 in the stator 52, and of the tooth 51 and/or slot 53 shape in the stator 52.

The current supplied to the stator 52 of the motor 50 from the motor drive 30 includes both fundamental and harmonic components. The fundamental component is the primary work producing component and, ideally, is the only component present to cause rotation of the rotor 54. The frequency of the fundamental component of current applied to the motor 50 determines the speed at which the motor rotates. The fundamental current in the stator winding 55 generates a rotating electromagnetic field within the motor, where the speed at which the electromagnetic field rotates around the motor is a function of the frequency of the current and of the number of poles within the motor. The magnets 61 in the rotor 54 of the motor 50 establish a constant magnetic field. The rotating electromagnetic field resulting from the fundamental current applied to the stator interacts with the constant magnetic field of the rotor to cause rotation of the motor.

Harmonic components present in the current waveform are a result of modulation techniques used to generate the variable amplitude and variable frequency voltage output from the motor drive 30. While the speed of the motor 50 is controlled by the fundamental component of the current, the harmonic components also effect operation of the motor 50. The harmonic components generate a ripple current present on top of the fundamental component and cause undesirable power losses within the motor 50. Each component of the current (i.e., fundamental and harmonic) create rotating electromagnetic fields within the motor 50 as a function of the frequency of the respective component. Because the amplitude of the fundamental component is significantly greater than the amplitude of any of the harmonic components, the rotating electromagnetic field generated by the fundamental component dominates performance and engages the magnetic field produced by the magnets 61 to control operation of the motor. The other rotating electromagnetic fields, however, still exert a force on the magnetic field produced by the magnets 61 and can cause a ripple torque on the rotor 54 corresponding to the ripple current observed on the current waveform. Additionally, the rotating electromagnetic fields of the harmonic components may establish eddy currents in the magnets 61 themselves, which, in turn, are dissipated as heat losses in the magnets.

The pick-up coil(s) 63 mounted to the rotor 54 reduces the ripple current and eddy currents generated by the harmonic components in the current. When a coil is present in a rotating electromagnetic field, a voltage is induced in the coil. Because the rotor 54 rotates synchronously with the fundamental component of the current, the pick-up coil 63 mounted to the rotor 54 experiences no rotational electromagnetic field from the fundamental component. The electromagnetic fields generated by the harmonic components, however, rotate at frequencies other than the fundamental frequency, and the pick-up coil(s) 63 mounted to the rotor experiences a rotating electromagnetic field, where the frequency of rotation of the rotating electromagnetic field, as experienced by the pick-up coil(s) is the difference between the frequency of the harmonic component and the fundamental component. These rotating electromagnetic fields experienced by the pick-up coil(s) 63 induce a voltage in the pick-up coil. This voltage induced in the pick-up coil results in wireless, or contactless, power transfer from the stator 52 to the rotor 54 and may be used to supply power to a circuit mounted on the rotor 54.

With reference also to FIGS. 5 and 6, a capacitive element 78 may be operatively connected to the pick-up coil 63. The capacitive element 78 may be a single capacitor or multiple capacitors connected in series, parallel, or a combination thereof. The inductive nature of the pick-up coil 63 in combination with the capacitive element 78 forms an L-C circuit. The inductance and capacitance values may be selected to establish a resonance in the L-C circuit at a frequency that is coincident with the frequency of one of the harmonic components. The resonance will increase the efficiency and capacity of power transfer between the electromagnetic field established by the corresponding harmonic component and the pick-up coil 63. Optionally, an additional inductor may also be connected with the pick-up coil 63 and the capacitive element 78 to obtain a desired resonance from the L-C circuit. Selecting the capacitor and/or inductive values to coincide with a resonant operating point of the L-C circuit, increases the capacity of power transfer from the electromagnetic field established by the corresponding harmonic component to the pick-up coil 63.

Turning next to FIG. 4, a schematic representation of a communication circuit between a rotating member of the motor 50 and the motor drive 30 is illustrated. The left portion of the illustrated communication circuit is mounted on the motor 50 and is one example of a circuit mounted to the rotor 54 which may receive power from the pick-up coil(s) 63. A circuit board 76 includes a processor 90 and a memory device 92 mounted to the board. The processor 90 may be any suitable processor according to the module requirements. It is contemplated that processor 90 may include a single processing device or multiple processing devices executing in parallel and may be implemented in separate electronic devices or incorporated on a single electronic device, such as a microprocessor, a field programmable gate array (FPGA) or application specific integrated circuit (ASIC). Similarly, the memory device 92 may be a single device, multiple devices or may be incorporated in part or in whole within the FPGA or ASIC. With reference also to FIGS. 5 and 6, it is contemplated that the circuit board 76 may be circular and include an opening extending through the center of the board such that the circuit board 76 may be mounted on the drive shaft 56. The circuit board 76 further includes a dedicated logic circuit 94 which includes components required to implement the physical layer of an Ethernet communication interface.

A digital rotary transformer 70 is mounted between the circuit board 76 and an Ethernet plug 81 on the motor 50. The digital rotary transformer 70 includes a primary winding 72 and a secondary winding 74. The primary winding 72 may be mounted on or adjacent to the circuit board 76. The primary winding 72 rotates with the rotor 54 and receives the Ethernet data packets from the dedicated logic circuit 94. With reference first to FIG. 5, the digital rotary transformer 70 includes a primary winding 72 and a secondary winding 74 mounted in planes adjacent to each other. An air gap exists between the windings, and the secondary winding 74 is mounted to a stationary feature within the motor such as the brake housing or to the interior of the motor housing. With reference next to FIG. 6, the digital rotary transformer 70 includes a primary winding 72 and a secondary winding 74 mounted coaxial to each other. An air gap is again present between windings, and the secondary winding 74 may be mounted to the stator 52 or interior housing of the motor. In either configuration, the primary winding 72 rotates with the rotor 54, and the Ethernet data packet is transmitted to the primary winding. The high frequency data of the Ethernet data packet is transmitted between the primary and secondary windings and conducted to the plug 81 on the motor 50.

The plugs 81, 83 on the motor 50 and motor drive 30 are preferably a standard Ethernet plug joined by a standard Ethernet cable 62. The type of plug and cable selected may be according to the application requirements. The plugs 81, 83 may be, for example, an RJ45 connector or an M12 connector. The cable may be a CAT-5, CAT-6, or CAT-7 cable. According to still another embodiment of the invention, a proprietary plug and cable configuration may be implemented without deviating from the scope of the invention. The plugs 81, 83 and cable 62 establish an Ethernet network between the motor 50 and the motor drive 30, delivering the Ethernet data packets generated on the rotor 54 of the motor.

Within the motor drive 30, the communication interface 64 may include a stationary digital transformer 100 to provide isolation for the physical layer circuit 102 within the motor drive. The communication interface 64 receives the Ethernet data packets and may transfer the data packets or perform some initial processing of the data packets and transmit data from the payload of the data packet to the feedback circuit 42 or to the processor 36 within the motor drive 30 for subsequent use.

According to another aspect of the invention, the processor 36 in the motor drive 30 may also be configured to transmit data to the processor 90 on the rotating member of the motor 50. Communication, as described above, from the rotating member of the motor 50 to the motor drive 30 may be bi-directional. Ethernet data packets may be transmitted in either direction across the digital rotary transformer 70.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A system for providing communication between a rotating member and a stationary member in a rotary machine, the system comprising:
an electronic circuit mounted on the rotating member of the rotary machine;
a power supply operative to provide power to the electronic circuit;
a transmitter operatively mounted in the electronic circuit, wherein the transmitter receives power from the power supply and wherein the transmitter is configured to generate Ethernet data packets;
a primary winding mounted to the rotating member of the rotary machine, wherein the primary winding is electrically connected to the transmitter to receive the Ethernet data packets;
a secondary winding mounted to the stationary member of the rotary machine, wherein the secondary winding is spaced apart from the primary winding by an air gap and wherein the secondary winding receives the Ethernet data packets via coupling between the primary and secondary windings; and
a receiver operatively connected to the secondary winding to receive the Ethernet data packets generated by the transmitter mounted on the rotating member of the rotary machine.

2. The system of claim 1 wherein the power supply further comprises:
a power source external to the rotary machine;
a power transmission device mounted on the stationary member of the rotary machine; and
a power receiving device mounted on the rotating member of the rotary machine, wherein the power provided to the electronic circuit is transmitted between the power transmission device and the power receiving device without contact between the power transmission device and the power receiving device.

3. The system of claim 2 wherein the power transmission device is defined by at least one stator winding operative to receive a voltage to cause rotation of the rotating member and wherein the power receiving device is at least one pick up coil mounted on the rotating member of the rotary machine.

4. The system of claim 1 further comprising:
a first transceiver operatively mounted in the electronic circuit, wherein the first transceiver includes the transmitter and an additional receiver; and
a second transceiver operatively connected to the secondary winding, wherein the second transceiver includes the receiver and an additional transmitter, and wherein the additional transmitter is operative to transmit Ethernet data packets to the additional receiver via the secondary and primary windings.

5. The system of claim 1 further comprising:
a first plug operatively connected to the secondary winding;
a second plug operatively connected in a device external from the rotary machine; and
a network cable configured to be inserted between the first plug and the second plug to transmit the Ethernet data packets from the rotary machine to the device external from the rotary machine.

6. A method for providing communication between a rotating member and a stationary member in a rotary machine, the method comprising the steps of:
generating Ethernet data packets with a transmitter operatively mounted on the rotating member of the rotary machine;
sending the Ethernet data packets from the transmitter to a primary winding mounted on the rotating member of the rotary machine;
receiving the Ethernet data packets at a secondary winding mounted to a stationary member of the rotary machine, wherein the secondary winding is spaced apart from the primary winding by an air gap and wherein the secondary winding receives the Ethernet data packets via coupling between the primary and secondary windings; and
transmitting the Ethernet data packets from the secondary winding to a receiver operatively connected to the secondary winding.

7. The method of claim 6 further comprising the step of receiving power on the rotating member of the rotary machine from a power source external to the rotary machine, wherein a power transmission device is mounted on the stationary member of the rotary machine and a power receiving device is mounted on the rotating member of the rotary machine.

8. The method of claim 7 wherein the power transmission device is defined by at least one stator winding operative to receive a voltage to cause rotation of the rotating member and wherein the power receiving device is at least one pick up coil mounted on the rotating member of the rotary machine.

9. The method of claim 6 wherein:
a first transceiver is operatively mounted on the rotating member of the rotary machine, wherein the first transceiver includes the transmitter and an additional receiver; and
a second transceiver is operatively connected to the secondary winding, wherein the second transceiver includes the receiver and an additional transmitter, the method further comprising the step of transmitting Ethernet data packets to the additional receiver from the additional transmitter via the secondary and primary windings.

10. A system for providing communication between a rotating member and a stationary member in a rotary machine, the system comprising:
a power supply external to the rotary machine;
a power transmission device mounted on the stationary member of the rotary machine and operatively connected to the power supply to receive power from the power supply;
a power receiving device mounted on the rotating member of the rotary machine, wherein the power receiving device is operative to receive power from the power transmission device via contactless delivery of power;
an electronic circuit mounted on the rotating member of the rotary machine, wherein the electronic circuit receives power from the power receiving device;
a transmitter operatively mounted in the electronic circuit, wherein the transmitter is configured to generate Ethernet data packets;
a digital rotary transformer including a primary side mounted to the rotating member of the rotary machine and a secondary side mounted to the stationary member of the rotary machine wherein the primary side of the digital rotary transformer is operatively connected to the transmitter to receive the Ethernet data packets and wherein the Ethernet data packets are transmitted between the primary side and the secondary side; and
a receiver operatively connected to the secondary winding to receive the Ethernet data packets generated by the transmitter mounted on the rotating member of the rotary machine.

11. The system of claim 10 wherein the power transmission device is defined by at least one stator winding operative to receive a voltage to cause rotation of the rotating member and wherein the power receiving device is at least one pick up coil mounted on the rotating member of the rotary machine.

12. The system of claim 10 further comprising:
a first transceiver operatively mounted in the electronic circuit, wherein the first transceiver includes the transmitter and an additional receiver; and
a second transceiver operatively connected to the secondary winding, wherein the second transceiver includes the receiver and an additional transmitter, and wherein the additional transmitter is operative to transmit Ethernet data packets to the additional receiver via the secondary and primary windings.

13. The system of claim 10 further comprising:
a first plug operatively connected to the secondary winding;
a second plug operatively connected in a device external from the rotary machine; and
a network cable configured to be inserted between the first plug and the second plug to transmit the Ethernet data packets from the rotary machine to the device external from the rotary machine.
